(19) United States
(12) Patent Application Publication
(10) Pub. No.: US 2022/0300755 A1
(43) Pub. Date: Sep. 22, 2022

(54) Method, System, and Computer Program Product for Predicting Future States Based on Time Series Data Using Feature Engineering and/or Hybrid Machine Learning Models

(71) Applicant: Visa International Service Association, San Francisco, CA (US)

(72) Inventors: Neha Vyas, San Francisco, CA (US); Gourab Basu, Half Moon Bay, CA (US); Yiwei Cai, Mercer Island, WA (US); Dan Wang, Austin, TX (US); Peng Wu, College Station, TX (US); Michael Kenji Mori, San Mateo, CA (US)

(21) Appl. No.: 17/695,944

(22) Filed: Mar. 16, 2022

Related U.S. Application Data
(60) Provisional application No. 63/161,715, filed on Mar. 16, 2021.

(51) Int. Cl. G06K 9/62; G06N 5/00; G06Q 20/38

(52) U.S. Cl. CPC G06K 9/6227; G06N 5/003; G06K 9/6256; G06Q 20/389

(57) ABSTRACT

Provided is a method for predicting future states based on time series data using feature engineering and/or hybrid machine learning models. The method may include receiving payment transaction data associated with a plurality of payment transactions, the plurality of payment transactions including a first subset of payment transactions associated with a first entity; determining a plurality of features based on the payment transaction data associated with the plurality of payment transactions; inputting the plurality of features into at least one machine learning model to provide at least one prediction of a net settlement position of the first entity; and communicating the at least one prediction of the net settlement position to a first entity system associated with the first entity. A system and computer program product are also disclosed.

### CROSS-REFERENCE TO RELATED APPLICATION

The present application claims the benefit of U.S. Provisional Patent Application No. 63/161,715 filed Mar. 16, 2021, the disclosure of which is hereby incorporated by reference in its entirety.

### BACKGROUND

### 1. Field

This disclosed subject matter relates generally to methods, systems, and computer program products for predicting future states based on time series data and, in some particular embodiments or aspects, to a method, system, and computer program product for predicting future states based on time series data using feature engineering and/or hybrid machine learning models.

### 2. Technical Considerations

Certain techniques may include and/or rely on time series data (e.g., data items that include a timestamp, time index, time ordering, and/or the like for each data item). For example, events may occur at different times, and time series data may include a plurality of data items including a time-based data item (e.g., timestamp, time index, time ordering, and/or the like) for each event. For the purpose of illustration, millions of payment transactions may occur at different times each day, and each payment transaction may have at least one message (e.g., authorization request, authorization response, clearing message, settlement message, and/or the like) associated therewith. Each such message may include a plurality of data fields including a time-based data field (e.g., timestamp, time index, time ordering, and/or the like). Predicting future events (e.g., payment transactions) and/or future states (e.g., an account balance at one or more times in the future) may be useful in certain situations.

However, making such predictions may be challenging. For example, it may be difficult to determine which data items (e.g., data fields of messages associated with payment transactions) and/or which aggregations thereof should be used as features (e.g., inputs) for a machine learning model. Using too many features may result in wasted computational resources, especially when the volume of data is very large (e.g., millions of payment transaction messages, each including multiple data fields). Additionally, using features that are poorly correlated and/or not correlated with the target prediction(s) may result in inaccuracy. Further, different types of machine learning models may be better at learning certain types of patterns and/or correlations than others. As such, by selecting a particular type of machine learning model, a user may introduce bias in the prediction(s) because the selected machine learning model may learn certain types of patterns and/or correlations better than others. This may result in inaccuracy and/or failure of the selected machine learning model to learn certain patterns and/or correlations that may be useful in making the target prediction(s).

### SUMMARY

Accordingly, it is an object of the presently disclosed subject matter to provide methods, systems, and computer program products for predicting future states based on time series data using feature engineering and/or hybrid machine learning models that overcome some or all of the deficiencies identified above.

According to non-limiting embodiments or aspects, provided is a method for predicting future states based on time series data using feature engineering and/or hybrid machine learning models. In some non-limiting embodiments or aspects, a method for predicting future states based on time series data using feature engineering and/or hybrid machine learning models may include receiving, with at least one processor, payment transaction data associated with a plurality of payment transactions, the plurality of payment transactions including a first subset of payment transactions associated with a first entity; determining, with the at least one processor, a plurality of features based on the payment transaction data associated with the plurality of payment transactions; inputting, with the at least one processor, the plurality of features into at least one machine learning model to provide at least one prediction of a net settlement position of the first entity; and communicating, with the at least one processor, the at least one prediction of the net settlement position to a first entity system associated with the first entity.

In some non-limiting embodiments or aspects, the payment transaction data associated with each transaction of the first subset of payment transactions comprises an account identifier associated with the first entity.

In some non-limiting embodiments or aspects, the account identifier comprises at least one of a settlement reporting entity (SRE) number, a funds transfer SRE (FTSRE) number, a business identification (BID) number, or any combination thereof.

In some non-limiting embodiments or aspects, the payment transaction data comprises at least one of historical transaction data, historical settlement position data, daily settlement data, real-time authorization data, or any combination thereof.

In some non-limiting embodiments or aspects, determining the plurality of features comprises determining the plurality of features based on a random forest model.

In some non-limiting embodiments or aspects, determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

In some non-limiting embodiments or aspects, the at least one machine learning model comprises at least one of an additive regression model, a Prophet model, or any combination thereof.

In some non-limiting embodiments or aspects, the Prophet model comprises an additive regression model comprising at least one of: a piecewise linear or logistic growth curve trend; a yearly seasonal component modeled using Fourier series; a weekly seasonal component; a list of holidays; or any combination thereof.

In some non-limiting embodiments or aspects, inputting the plurality of features into at least one machine learning model comprises: inputting the plurality of features into a denoising autoencoder (DAE) to provide denoised features; inputting the denoised features into a convolutional neural network (CNN) to provide filtered data; inputting the filtered data into at least one feature extraction layer to provide extracted features; and inputting at least one of the plurality of features or the extracted features into a long short-term memory (LSTM) model to provide the at least one prediction of the net settlement position of the first entity.

In some non-limiting embodiments or aspects, the DAE comprises a recurrent neural network (RNN) autoencoder.

In some non-limiting embodiments or aspects, the at least one feature extraction layer comprises at least one fully connected neural network layer.

In some non-limiting embodiments or aspects, inputting the at least one of the plurality of features or the extracted features into the LSTM model to provide the at least one prediction comprises inputting an output of the LSTM model to a sequence decoder to provide the at least one prediction.

In some non-limiting embodiments or aspects, the at least one prediction comprises a plurality of predictions comprising a respective prediction of the net settlement position of the first entity for each subperiod of a time period.

In some non-limiting embodiments or aspects, the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

In some non-limiting embodiments or aspects, wherein communicating the at least one prediction comprises communicating the at least one prediction to the first entity system via at least one of a graphical user interface (GUI) or an application programming interface (API).

According to non-limiting embodiments or aspects, provided is a system for predicting future states based on time series data using feature engineering and/or hybrid machine learning models. In some non-limiting embodiments or aspects, the system for predicting future states based on time series data using feature engineering and/or hybrid machine learning models may include at least one processor and at least one non-transitory computer-readable medium including one or more instructions that, when executed by the at least one processor, direct the at least one processor to receive payment transaction data associated with a plurality of payment transactions, the plurality of payment transactions including a first subset of payment transactions associated with a first entity; determine a plurality of features based on the payment transaction data associated with the plurality of payment transactions; input the plurality of features into at least one machine learning model to provide at least one prediction of a net settlement position of the first entity; and communicate the at least one prediction of the net settlement position to a first entity system associated with the first entity.

In some non-limiting embodiments or aspects, the payment transaction data associated with each transaction of the first subset of payment transactions comprises an account identifier associated with the first entity.

In some non-limiting embodiments or aspects, the account identifier comprises at least one of an SRE number, an FTSRE number, a BID number, or any combination thereof.

In some non-limiting embodiments or aspects, the payment transaction data comprises at least one of historical transaction data, historical settlement position data, daily settlement data, real-time authorization data, or any combination thereof.

In some non-limiting embodiments or aspects, determining the plurality of features comprises determining the plurality of features based on a random forest model.

In some non-limiting embodiments or aspects, determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

In some non-limiting embodiments or aspects, the at least one machine learning model comprises at least one of an additive regression model, a Prophet model, or any combination thereof.

In some non-limiting embodiments or aspects, the Prophet model comprises an additive regression model comprising at least one of: a piecewise linear or logistic growth curve trend; a yearly seasonal component modeled using Fourier series; a weekly seasonal component; a list of holidays; or any combination thereof.

In some non-limiting embodiments or aspects, inputting the plurality of features into at least one machine learning model comprises: inputting the plurality of features into a DAE to provide denoised features; inputting the denoised features into a CNN to provide filtered data; inputting the filtered data into at least one feature extraction layer to provide extracted features; and inputting at least one of the plurality of features or the extracted features into an LSTM model to provide the at least one prediction of the net settlement position of the first entity.

In some non-limiting embodiments or aspects, the DAE comprises an RNN autoencoder.

In some non-limiting embodiments or aspects, the at least one feature extraction layer comprises at least one fully connected neural network layer.

In some non-limiting embodiments or aspects, inputting the at least one of the plurality of features or the extracted features into the LSTM model to provide the at least one prediction comprises inputting an output of the LSTM model to a sequence decoder to provide the at least one prediction.

In some non-limiting embodiments or aspects, the at least one prediction comprises a plurality of predictions comprising a respective prediction of the net settlement position of the first entity for each subperiod of a time period.

In some non-limiting embodiments or aspects, the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

In some non-limiting embodiments or aspects, wherein communicating the at least one prediction comprises communicating the at least one prediction to the first entity system via at least one of a GUI or an API.

According to non-limiting embodiments or aspects, provided is a computer program product for predicting future states based on time series data using feature engineering and/or hybrid machine learning models. The computer program product may include at least one non-transitory computer-readable medium including one or more instructions that, when executed by at least one processor, cause the at least one processor to receive payment transaction data associated with a plurality of payment transactions, the plurality of payment transactions including a first subset of payment transactions associated with a first entity; determine a plurality of features based on the payment transaction data associated with the plurality of payment transactions; input the plurality of features into at least one machine learning model to provide at least one prediction of a net settlement position of the first entity; and communicate the at least one prediction of the net settlement position to a first entity system associated with the first entity.

In some non-limiting embodiments or aspects, the payment transaction data associated with each transaction of the first subset of payment transactions comprises an account identifier associated with the first entity.

In some non-limiting embodiments or aspects, the account identifier comprises at least one of an SRE number, an FTSRE number, a BID number, or any combination thereof.

In some non-limiting embodiments or aspects, the payment transaction data comprises at least one of historical transaction data, historical settlement position data, daily settlement data, real-time authorization data, or any combination thereof.

In some non-limiting embodiments or aspects, determining the plurality of features comprises determining the plurality of features based on a random forest model.

In some non-limiting embodiments or aspects, determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

In some non-limiting embodiments or aspects, the at least one machine learning model comprises at least one of an additive regression model, a Prophet model, or any combination thereof.

In some non-limiting embodiments or aspects, the Prophet model comprises an additive regression model comprising at least one of: a piecewise linear or logistic growth curve trend; a yearly seasonal component modeled using Fourier series; a weekly seasonal component; a list of holidays; or any combination thereof.

In some non-limiting embodiments or aspects, inputting the plurality of features into at least one machine learning model comprises: inputting the plurality of features into a DAE to provide denoised features; inputting the denoised features into a CNN to provide filtered data; inputting the filtered data into at least one feature extraction layer to provide extracted features; and inputting at least one of the plurality of features or the extracted features into an LSTM model to provide the at least one prediction of the net settlement position of the first entity.

In some non-limiting embodiments or aspects, the DAE comprises an RNN autoencoder.

In some non-limiting embodiments or aspects, the at least one feature extraction layer comprises at least one fully connected neural network layer.

In some non-limiting embodiments or aspects, inputting the at least one of the plurality of features or the extracted features into the LSTM model to provide the at least one prediction comprises inputting an output of the LSTM model to a sequence decoder to provide the at least one prediction.

In some non-limiting embodiments or aspects, the at least one prediction comprises a plurality of predictions comprising a respective prediction of the net settlement position of the first entity for each subperiod of a time period.

In some non-limiting embodiments or aspects, the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

In some non-limiting embodiments or aspects, wherein communicating the at least one prediction comprises communicating the at least one prediction to the first entity system via at least one of a GUI or an API.

Further embodiments or aspects are set forth in the following numbered clauses:

Clause 1: A computer-implemented method, comprising: receiving, with at least one processor, payment transaction data associated with a plurality of payment transactions, the plurality of payment transactions including a first subset of payment transactions associated with a first entity; determining, with the at least one processor, a plurality of features based on the payment transaction data associated with the plurality of payment transactions; inputting, with the at least one processor, the plurality of features into at least one machine learning model to provide at least one prediction of a net settlement position of the first entity; and communicating, with the at least one processor, the at least one prediction of the net settlement position to a first entity system associated with the first entity.

Clause 2: The computer-implemented method of clause 1, wherein the payment transaction data associated with each transaction of the first subset of payment transactions comprises an account identifier associated with the first entity.

Clause 3: The computer-implemented method of any preceding clause, wherein the account identifier comprises at least one of a settlement reporting entity (SRE) number, a funds transfer SRE (FTSRE) number, a business identification (BID) number, or any combination thereof.

Clause 4: The computer-implemented method of any preceding clause, wherein the payment transaction data comprises at least one of historical transaction data, historical settlement position data, daily settlement data, real-time authorization data, or any combination thereof.

Clause 5: The computer-implemented method of any preceding clause, wherein determining the plurality of features comprises determining the plurality of features based on a random forest model.

Clause 6: The computer-implemented method of any preceding clause, wherein determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

Clause 7: The computer-implemented method of any preceding clause, wherein the at least one machine learning model comprises at least one of an additive regression model, a Prophet model, or any combination thereof.

Clause 8: The computer-implemented method of any preceding clause, wherein the Prophet model comprises the additive regression model comprising at least one of: a piecewise linear or logistic growth curve trend; a yearly seasonal component modeled using Fourier series; a weekly seasonal component; a list of holidays; or any combination thereof.

Clause 9: The computer-implemented method of any preceding clause, wherein inputting the plurality of features into the at least one machine learning model comprises: inputting the plurality of features into a denoising autoencoder (DAE) to provide denoised features; inputting the denoised features into a convolutional neural network (CNN) to provide filtered data; inputting the filtered data into at least one feature extraction layer to provide extracted features; and inputting at least one of the plurality of features or the extracted features into a long short-term memory (LSTM) model to provide the at least one prediction of the net settlement position of the first entity.

Clause 10: The computer-implemented method of any preceding clause, wherein the DAE comprises a recurrent neural network (RNN) autoencoder.

Clause 11: The computer-implemented method of any preceding clause, wherein the at least one feature extraction layer comprises at least one fully connected neural network layer.

Clause 12: The computer-implemented method of any preceding clause, wherein inputting the at least one of the plurality of features or the extracted features into the LSTM model to provide the at least one prediction comprises inputting an output of the LSTM model to a sequence decoder to provide the at least one prediction.

Clause 13: The computer-implemented method of any preceding clause, wherein the at least one prediction comprises a plurality of predictions comprising a respective prediction of the net settlement position of the first entity for each subperiod of a time period.

Clause 14: The computer-implemented method of any preceding clause, wherein the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

Clause 15: The computer-implemented method of any preceding clause, wherein communicating the at least one prediction comprises communicating the at least one prediction to the first entity system via at least one of a graphical user interface (GUI) or an application programming interface (API).

Clause 16: A system, comprising: at least one processor; and at least one non-transitory computer-readable medium including one or more instructions that, when executed by the at least one processor, direct the at least one processor to: receive payment transaction data associated with a plurality of payment transactions, the plurality of payment transactions including a first subset of payment transactions associated with a first entity; determine a plurality of features based on the payment transaction data associated with the plurality of payment transactions; input the plurality of features into at least one machine learning model to provide at least one prediction of a net settlement position of the first entity; and communicate the at least one prediction of the net settlement position to a first entity system associated with the first entity.

Clause 17: The system of clause 16, wherein the payment transaction data associated with each transaction of the first subset of payment transactions comprises an account identifier associated with the first entity.

Clause 18: The system of clause 16 or clause 17, wherein the account identifier comprises at least one of a settlement reporting entity (SRE) number, a funds transfer SRE (FTSRE) number, a business identification (BID) number, or any combination thereof.

Clause 19: The system of any one of clauses 16-18, wherein the payment transaction data comprises at least one of historical transaction data, historical settlement position data, daily settlement data, real-time authorization data, or any combination thereof.

Clause 20: The system of any one of clauses 16-19, wherein determining the plurality of features comprises determining the plurality of features based on a random forest model.

Clause 21: The system of any one of clauses 16-20, wherein determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

Clause 22: The system of any one of clauses 16-21, wherein the at least one machine learning model comprises at least one of an additive regression model, a Prophet model, or any combination thereof.

Clause 23: The system of any one of clauses 16-22, wherein the Prophet model comprises the additive regression model comprising at least one of: a piecewise linear or logistic growth curve trend; a yearly seasonal component modeled using Fourier series; a weekly seasonal component; a list of holidays; or any combination thereof.

Clause 24: The system of any one of clauses 16-23, wherein inputting the plurality of features into the at least one machine learning model comprises: inputting the plurality of features into a denoising autoencoder (DAE) to provide denoised features; inputting the denoised features into a convolutional neural network (CNN) to provide filtered data; inputting the filtered data into at least one feature extraction layer to provide extracted features; and inputting at least one of the plurality of features or the extracted features into a long short-term memory (LSTM) model to provide the at least one prediction of the net settlement position of the first entity.

Clause 25: The system of any one of clauses 16-24, wherein the DAE comprises a recurrent neural network (RNN) autoencoder.

Clause 26: The system of any one of clauses 16-25, wherein the at least one feature extraction layer comprises at least one fully connected neural network layer.

Clause 27: The system of any one of clauses 16-26, wherein inputting the at least one of the plurality of features or the extracted features into the LSTM model to provide the at least one prediction comprises inputting an output of the LSTM model to a sequence decoder to provide the at least one prediction.

Clause 28: The system of any one of clauses 16-27, wherein the at least one prediction comprises a plurality of predictions comprising a respective prediction of the net settlement position of the first entity for each subperiod of a time period.

Clause 29: The system of any one of clauses 16-28, wherein the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

Clause 30: The system of any one of clauses 16-29, wherein communicating the at least one prediction comprises communicating the at least one prediction to the first entity system via at least one of a graphical user interface (GUI) or an application programming interface (API).

Clause 31: A computer program product comprising at least one non-transitory computer-readable medium including one or more instructions that, when executed by at least one processor, cause the at least one processor to: receive payment transaction data associated with a plurality of payment transactions, the plurality of payment transactions including a first subset of payment transactions associated with a first entity; determine a plurality of features based on the payment transaction data associated with the plurality of payment transactions; input the plurality of features into at least one machine learning model to provide at least one prediction of a net settlement position of the first entity; and communicate the at least one prediction of the net settlement position to a first entity system associated with the first entity.

Clause 32: The computer program product of clause 31, wherein the payment transaction data associated with each transaction of the first subset of payment transactions comprises an account identifier associated with the first entity.

Clause 33: The computer program product of clause 31 or clause 32, wherein the account identifier comprises at least one of a settlement reporting entity (SRE) number, a funds transfer SRE (FTSRE) number, a business identification (BID) number, or any combination thereof.

Clause 34: The computer program product of any one of clauses 31-33, wherein the payment transaction data comprises at least one of historical transaction data, historical settlement position data, daily settlement data, real-time authorization data, or any combination thereof.

Clause 35: The computer program product of any one of clauses 31-34, wherein determining the plurality of features comprises determining the plurality of features based on a random forest model.

Clause 36: The computer program product of any one of clauses 31-35, wherein determining the plurality of features based on the random forest model comprises: receiving a first plurality of features; evaluating the first plurality of features with the random forest model to rank the first plurality of features based on a respective level of impact of each respective features of the first plurality of features on an output of the at least one machine learning model; and selecting a second plurality of features based on ranking of the first plurality of features, wherein the second plurality of features comprises the plurality of features.

Clause 37: The computer program product of any one of clauses 31-36, wherein the at least one machine learning model comprises at least one of an additive regression model, a Prophet model, or any combination thereof.

Clause 38: The computer program product of any one of clauses 31-37, wherein the Prophet model comprises the additive regression model comprising at least one of: a piecewise linear or logistic growth curve trend; a yearly seasonal component modeled using Fourier series; a weekly seasonal component; a list of holidays; or any combination thereof.

Clause 39: The computer program product of any one of clauses 31-38, wherein inputting the plurality of features into the at least one machine learning model comprises: inputting the plurality of features into a denoising autoencoder (DAE) to provide denoised features; inputting the denoised features into a convolutional neural network (CNN) to provide filtered data; inputting the filtered data into at least one feature extraction layer to provide extracted features; and inputting at least one of the plurality of features or the extracted features into a long short-term memory (LSTM) model to provide the at least one prediction of the net settlement position of the first entity.

Clause 40: The computer program product of any one of clauses 31-39, wherein the DAE comprises a recurrent neural network (RNN) autoencoder.

Clause 41: The computer program product of any one of clauses 31-40, wherein the at least one feature extraction layer comprises at least one fully connected neural network layer.

Clause 42: The computer program product of any one of clauses 31-41, wherein inputting the at least one of the plurality of features or the extracted features into the LSTM model to provide the at least one prediction comprises inputting an output of the LSTM model to a sequence decoder to provide the at least one prediction.

Clause 43: The computer program product of any one of clauses 31-42, wherein the at least one prediction comprises a plurality of predictions comprising a respective prediction of the net settlement position of the first entity for each subperiod of a time period.

Clause 44: The computer program product of any one of clauses 31-43, wherein the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

Clause 45: The computer program product of any one of clauses 31-44, wherein communicating the at least one prediction comprises communicating the at least one prediction to the first entity system via at least one of a graphical user interface (GUI) or an application programming interface (API).

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of an exemplary environment in which methods, systems, and/or computer program products, described herein, may be implemented, according to non-limiting embodiments or aspects of the presently disclosed subject matter;

FIG. 2 is a diagram of exemplary components of one or more devices of FIG. 1, according to non-limiting embodiments or aspects of the presently disclosed subject matter;

FIG. 3 is a flowchart of an exemplary process for predicting future states based on time series data using feature engineering and/or hybrid machine learning models, according to non-limiting embodiments or aspects of the presently disclosed subject matter;

FIG. 4 is a diagram an exemplary implementation of the process shown in FIG. 3, according to non-limiting embodiments or aspects of the presently disclosed subject matter;

FIGS. 5A and 5B are diagrams of an exemplary implementation of the process shown in FIG. 3, according to non-limiting embodiments or aspects of the presently disclosed subject matter;

FIGS. 6A-6C are graphs of exemplary performance metrics of an exemplary implementation of the process shown in FIG. 3, according to non-limiting embodiments or aspects of the presently disclosed subject matter; and

FIGS. 7A-7C are screenshots of exemplary graphical user interfaces of exemplary implementations of the process shown in FIG. 3, according to non-limiting embodiments or aspects of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term “token service provider” may refer to an entity, including one or more server computers in a token service system that generates, processes, and maintains payment tokens. For example, the token service provider may include or be in communication with a token vault, where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services, according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “computing device” may refer to one or more electronic devices that are configured to directly or indirectly communicate with or over one or more networks. A computing device may be a mobile device, a desktop computer, and/or any other like device. Furthermore, the term “computer” may refer to any computing device that includes the necessary components to receive, process, and output data, and normally includes a display, a processor, a memory, an input device, and a network interface. As used herein, the term “server” may refer to or include one or more processors or computers, storage devices, or similar computer arrangements that are operated by or facilitate communication and/or processing in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

The term “processor,” as used herein, may represent any type of processing unit, such as a single processor having one or more cores, one or more cores of one or more processors, multiple processors each having one or more cores, and/or other arrangements and combinations of processing units.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

For the purpose of illustration, in the following description, while the presently disclosed subject matter is described with respect to methods, systems, and computer program products for predicting future states based on time series data using feature engineering and/or hybrid machine learning models, e.g., for payment transactions and/or accounts, one skilled in the art will recognize that the disclosed subject matter is not limited to the illustrative embodiments or aspects. For example, the methods, systems, and computer program products described herein may be used with a wide variety of settings, such as predicting future events and/or states associated therewith in any setting suitable for using time series data, e.g., predicting fraud, interactions between entities, weather events, medical events, disasters, public events, and/or states of entities, places, and/or accounts based on such events.

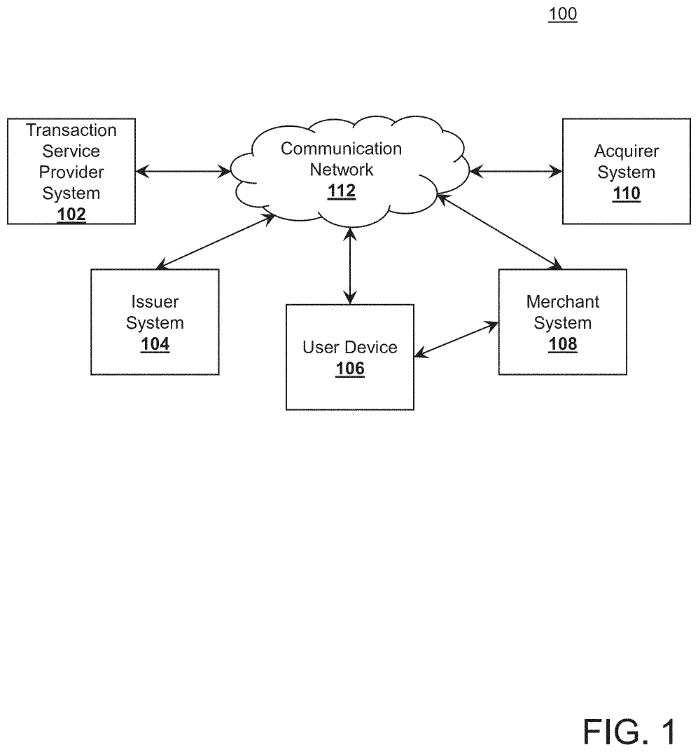

Referring now to FIG. 1, FIG. 1 is a diagram of an exemplary environment 100 in which systems, products, and/or methods, as described herein, may be implemented, according to non-limiting embodiments or aspects of the presently disclosed subject matter. As shown in FIG. 1, environment 100 includes transaction service provider system 102, issuer system 104, user device 106, merchant system 108, acquirer system 110, and communication network 112.

Transaction service provider system 102 may include one or more devices capable of receiving information from and/or communicating information to issuer system 104, user device 106, merchant system 108, and/or acquirer system 110 via communication network 112. For example, transaction service provider system 102 may include a computing device, such as a server (e.g., a transaction processing server), a group of servers, and/or other like devices. In some non-limiting embodiments or aspects, transaction service provider system 102 may be associated with a transaction service provider, as described herein. In some non-limiting embodiments or aspects, transaction service provider system 102 may be in communication with a data storage device, which may be local or remote to transaction service provider system 102. In some non-limiting embodiments or aspects, transaction service provider system 102 may be capable of receiving information from, storing information in, communicating information to, or searching information stored in the data storage device.

Issuer system 104 may include one or more devices capable of receiving information and/or communicating information to transaction service provider system 102, user device 106, merchant system 108, and/or acquirer system 110 via communication network 112. For example, issuer system 104 may include a computing device, such as a server, a group of servers, and/or other like devices. In some non-limiting embodiments or aspects, issuer system 104 may be associated with an issuer institution, as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, merchant system 108, and/or acquirer system 110 via communication network 112. Additionally or alternatively, each user device 106 may include a device capable of receiving information from and/or communicating information to other user devices 106 via communication network 112, another network (e.g., an ad hoc network, a local network, a private network, a virtual private network, and/or the like), and/or any other suitable communication technique. For example, user device 106 may include a client device and/or the like. In some non-limiting embodiments or aspects, user device 106 may or may not be capable of receiving information (e.g., from merchant system 108 or from another user device 106) via a short-range wireless communication connection (e.g., an NFC communication connection, an RFID communication connection, a Bluetooth® communication connection, a Zigbee® communication connection, and/or the like), and/or communicating information (e.g., to merchant system 108) via a short-range wireless communication connection.

Merchant system 108 may include one or more devices capable of receiving information from and/or communicating information to transaction service provider system 102, issuer system 104, user device 106, and/or acquirer system 110 via communication network 112. Merchant system 108 may also include a device capable of receiving information from user device 106 via communication network 112, a communication connection (e.g., an NFC communication connection, an RFID communication connection, a Bluetooth® communication connection, a Zigbee® communication connection, and/or the like) with user device 106, and/or the like, and/or communicating information to user device 106 via communication network 112, the communication connection, and/or the like. In some non-limiting embodiments or aspects, merchant system 108 may include a computing device, such as a server, a group of servers, a client device, a group of client devices, and/or other like devices. In some non-limiting embodiments or aspects, merchant system 108 may be associated with a merchant, as described herein. In some non-limiting embodiments or aspects, merchant system 108 may include one or more client devices. For example, merchant system 108 may include a client device that allows a merchant to communicate information to transaction service provider system 102. In some non-limiting embodiments or aspects, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or communicating information to transaction service provider system 102, issuer system 104, user device 106, and/or merchant system 108 via communication network 112. For example, acquirer system 110 may include a computing device, a server, a group of servers, and/or the like. In some non-limiting embodiments or aspects, acquirer system 110 may be associated with an acquirer, as described herein.

Communication network 112 may include one or more wired and/or wireless networks. For example, communication network 112 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, processing a transaction may include generating and/or communicating at least one transaction message (e.g., authorization request, authorization response, any combination thereof, and/or the like). For example, a client device (e.g., user device 106, a POS device of merchant system 108, and/or the like) may initiate the transaction, e.g., by generating an authorization request. Additionally or alternatively, the client device (e.g., user device 106, at least one device of merchant system 108, and/or the like) may communicate the authorization request. For example, user device 106 may communicate the authorization request to merchant system 108 and/or a payment gateway (e.g., a payment gateway of transaction service provider system 102, a third-party payment gateway separate from transaction service provider system 102, and/or the like). Additionally or alternatively, merchant system 108 (e.g., a POS device thereof) may communicate the authorization request to acquirer system 110 and/or a payment gateway. In some non-limiting embodiments or aspects, acquirer system 110 and/or a payment gateway may communicate the authorization request to transaction service provider system 102 and/or issuer system 104. Additionally or alternatively, transaction service provider system 102 may communicate the authorization request to issuer system 104. In some non-limiting embodiments or aspects, issuer system 104 may determine an authorization decision (e.g., authorize, decline, and/or the like) based on the authorization request. For example, the authorization request may cause issuer system 104 to determine the authorization decision based thereof. In some non-limiting embodiments or aspects, issue system 104 may generate an authorization response based on the authorization decision. Additionally or alternatively, issuer system 104 may communicate the authorization response. For example, issuer system 104 may communicate the authorization response to transaction service provider system 102 and/or a payment gateway. Additionally or alternatively, transaction service provider system 102 and/or a payment gateway may communicate the authorization response to acquirer system 110, merchant system 108, and/or user device 106. Additionally or alternatively, acquirer system 110 may communicate the authorization response to merchant system 108 and/or a payment gateway. Additionally or alternatively, a payment gateway may communicate the authorization response to merchant system 108 and/or user device 106. Additionally or alternatively, merchant system 108 may communicate the authorization response to user device 106. In some non-limiting embodiments or aspects, merchant system 108 may receive (e.g., from acquirer system 110 and/or a payment gateway) the authorization response. Additionally or alternatively, merchant system 108 may complete the transaction based on the authorization response (e.g., provide, ship, and/or deliver goods and/or services associated with the transaction; fulfill an order associated with the transaction; any combination thereof; and/or the like).

For the purpose of illustration, processing a transaction may include generating a transaction message (e.g., authorization request and/or the like) based on an account identifier of a customer (e.g., associated with user device 106 and/or the like) and/or transaction data associated with the transaction. For example, merchant system 108 (e.g., a client device of merchant system 108, a POS device of merchant system 108, and/or the like) may initiate the transaction, e.g., by generating an authorization request (e.g., in response to receiving the account identifier from a portable financial device of the customer and/or the like). Additionally or alternatively, merchant system 108 may communicate the authorization request to acquirer system 110. Additionally or alternatively, acquirer system 110 may communicate the authorization request to transaction service provider system 102. Additionally or alternatively, transaction service provider system 102 may communicate the authorization request to issuer system 104. Issuer system 104 may determine an authorization decision (e.g., authorize, decline, and/or the like) based on the authorization request, and/or issuer system 104 may generate an authorization response based on the authorization decision and/or the authorization request. Additionally or alternatively, issuer system 104 may communicate the authorization response to transaction service provider system 102. Additionally or alternatively, transaction service provider system 102 may communicate the authorization response to acquirer system 110, which may communicate the authorization response to merchant system 108.

For the purpose of illustration, clearing and/or settlement of a transaction may include generating a message (e.g., clearing message, settlement message, and/or the like) based on an account identifier of a customer (e.g., associated with user device 106 and/or the like) and/or transaction data associated with the transaction. For example, merchant system 108 may generate at least one clearing message (e.g., a plurality of clearing messages, a batch of clearing messages, and/or the like). Additionally or alternatively, merchant system 108 may communicate the clearing message(s) to acquirer system 110. Additionally or alternatively, acquirer system 110 may communicate the clearing message(s) to transaction service provider system 102. Additionally or alternatively, transaction service provider system 102 may communicate the clearing message(s) to issuer system 104. Additionally or alternatively, issuer system 104 may generate at least one settlement message based on the clearing message(s). Additionally or alternatively, issuer system 104 may communicate the settlement message(s) and/or funds to transaction service provider system 102 (and/or a settlement bank system associated with transaction service provider system 102). Additionally or alternatively, transaction service provider system 102 (and/or the settlement bank system) may communicate the settlement message(s) and/or funds to acquirer system 110, which may communicate the settlement message(s) and/or funds to merchant system 108 (and/or an account associated with merchant system 108).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

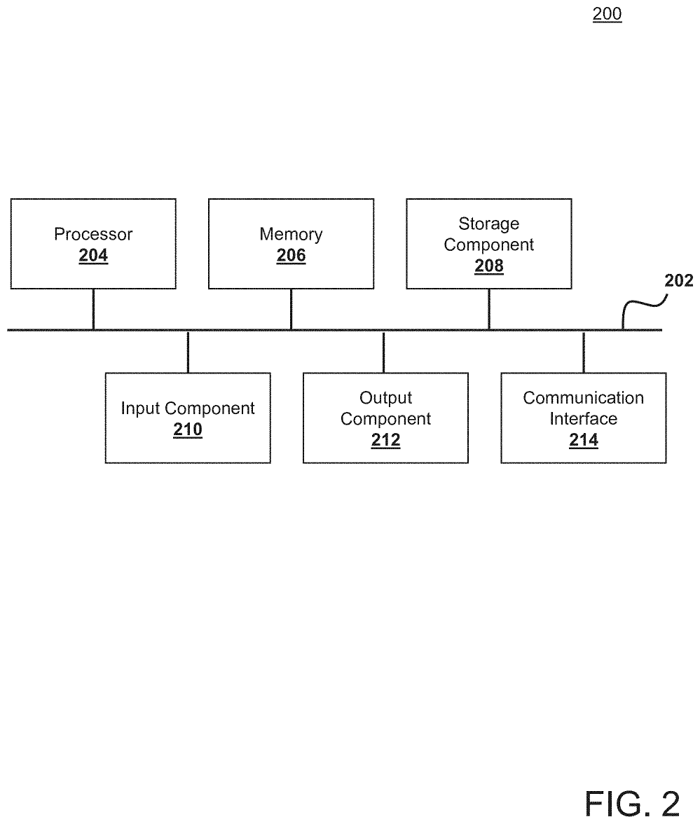

Referring now to FIG. 2, FIG. 2 is a diagram of exemplary components of a device 200, according to non-limiting embodiments or aspects of the presently disclosed subject matter. Device 200 may correspond to one or more devices of transaction service provider system 102, one or more devices of issuer system 104, user device 106, one or more devices of merchant system 108, and/or one or more devices of acquirer system 110. In some non-limiting embodiments or aspects, transaction service provider system 102, issuer system 104, user device 106, merchant system 108, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, firmware, and/or any combination thereof. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

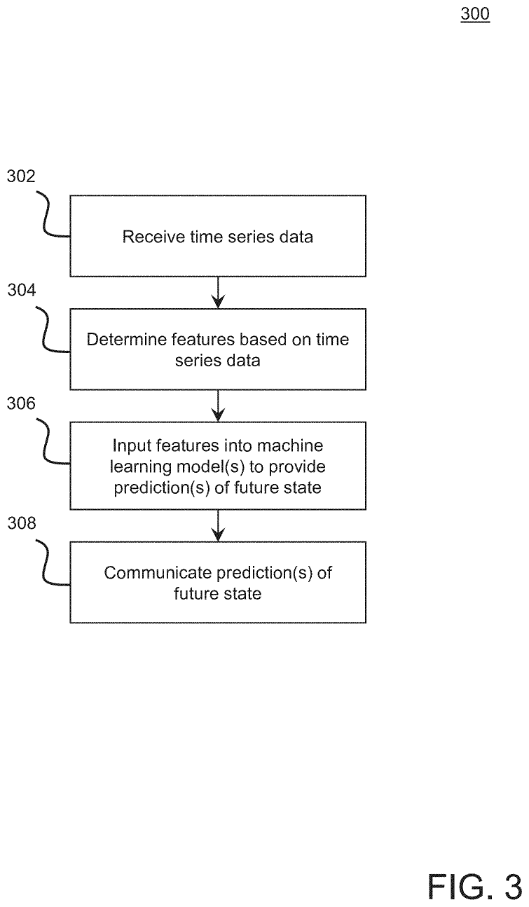

Referring now to FIG. 3, FIG. 3 is a flowchart of a process 300 for predicting future states based on time series data using feature engineering and/or hybrid machine learning models, according to non-limiting embodiments or aspects of the presently disclosed subject matter. In some non-limiting embodiments or aspects, one or more of the steps of process 300 may be performed (e.g., completely, partially, and/or the like) by transaction service provider system 102. In some non-limiting embodiments or aspects, one or more of the steps of processes for predicting future states based on time series data using feature engineering and/or hybrid machine learning models may be performed (e.g., completely, partially, and/or the like) by another system, another device, another group of systems, or another group of devices, separate from or including transaction service provider system 102, such as issuer system 104, user device 106, merchant system 108, acquirer system 110, device 200, and/or the like.

As shown in FIG. 3, at step 302, process 300 may include receiving time series data. For example, transaction service provider system 102 may receive time series data.

In some non-limiting embodiments or aspects, the time series data may include payment transaction data. For example, transaction service provider system 102 may receive payment transaction data associated with a plurality of payment transactions. In some non-limiting embodiments or aspects, the plurality of payment transactions may include a first subset of payment transactions associated with a first entity (e.g., an issuer, a customer/cardholder, a merchant, an acquirer, and/or the like).

In some non-limiting embodiments or aspects, the payment transaction data associated with each transaction of the first subset of payment transactions may include an account identifier associated with the first entity. For example, the account identifier may include at least one of a settlement reporting entity (SRE) number, a funds transfer SRE (FTSRE) number, a business identification (BID) number, any combination thereof, and/or the like.

In some non-limiting embodiments or aspects, the payment transaction data may include at least one of historical transaction data, historical settlement position data, daily settlement data, real-time authorization data, any combination thereof, and/or the like.

As shown in FIG. 3, at step 304, process 300 may include determining features based on the time series data. For example, transaction service provider system 102 may determine a plurality of features based on the time series data.

In some non-limiting embodiments or aspects, the time series data may include payment transaction data, as described herein. For example, transaction service provider system 102 may determine a plurality of features based on the payment transaction data associated with the plurality of payment transactions.

In some non-limiting embodiments or aspects, determining the plurality of features may include determining (e.g., by transaction service provider system 102) the plurality of features based on a random forest model. For example, transaction service provider system 102 may receiving a first plurality of features. Transaction service provider system 102 may evaluate the first plurality of features with the random forest model to rank the first plurality of features based on a respective level of impact of each respective features of the first plurality of features on an output of the at least one machine learning model. Additionally or alternatively, transaction service provider system 102 may select a second plurality of features based on ranking of the first plurality of features. For example, the second plurality of features may be the (determined) plurality of features.

In some non-limiting embodiments or aspects, the first plurality of features may include historical settlement data for each entity (e.g., FTSRE), such as country, region, entity (e.g., FTSRE) identifier, entity (e.g., FTSRE) name, settlement service identifier, currency name, settlement volume that is credited, settlement volume that is debited, billing fee/promotions volume (e.g., billing fee volume, promotions volume, any combination thereof, and/or the like), net settlement volume (e.g., sum of acquiring, issuing, and other columns), date settlement is provided, and/or date settlement volume needs to settle by; new settlement data for each entity (e.g., FTSRE), such as settlement service identifier, entity identifier, currency code, business identifier, net settlement volume, currency name, billing fee/promotions volume, settlement volume that is credited, settlement volume that is debited, date settlement is provided, and/or date settlement volume needs to settle by; authorization data for each entity (e.g., FTSRE), such as authorization volume (e.g., average absolute daily volume (AADV), authorization at the business identifier level, and/or the like), authorization requests, and/or authorization responses; any combination of these features; and/or the like.

As shown in FIG. 3, at step 306, process 300 may include inputting the features into at least one machine learning model to provide at least one prediction of a future state. For example, transaction service provider system 102 may input the features into at least one machine learning model to provide at least one prediction of a future state.

In some non-limiting embodiments or aspects, the time series data may include payment transaction data, as described herein and the future state may include a net settlement position of the first entity. For example, transaction service provider system 102 may input the plurality of features into at least one machine learning model to provide at least one prediction of a net settlement position of the first entity.

In some non-limiting embodiments or aspects, the at least one machine learning model may include at least one of an additive regression model, a Prophet model, any combination thereof, and/or the like. For example, the Prophet model may include an additive regression model comprising at least one of a piecewise linear or logistic growth curve trend, a yearly seasonal component modeled using Fourier series, a weekly seasonal component, a list of holidays, any combination thereof, and/or the like.

In some non-limiting embodiments or aspects, inputting the plurality of features into at least one machine learning model may include inputting the plurality of features into a denoising autoencoder (DAE) to provide denoised features, inputting the denoised features into a convolutional neural network (CNN) to provide filtered data, inputting the filtered data into at least one feature extraction layer to provide extracted features, and/or inputting at least one of the plurality of features or the extracted features into a long short-term memory (LSTM) model to provide the at least one prediction of the net settlement position of the first entity. In some non-limiting embodiments or aspects, the DAE may include a recurrent neural network (RNN) autoencoder. Additionally or alternatively, the at least one feature extraction layer may include at least one fully connected neural network layer. In some non-limiting embodiments or aspects, inputting the at least one of the plurality of features or the extracted features into the LSTM model to provide the at least one prediction may include inputting an output of the LSTM model to a sequence decoder to provide the at least one prediction.

In some non-limiting embodiments or aspects, the at least one prediction may include a plurality of predictions comprising a respective prediction of the net settlement position of the first entity for each subperiod of a time period. For example, the time period may be seven days, each subperiod may be one day of the seven days. As such, the plurality of predictions may include a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

As shown in FIG. 3, at step 308, process 300 may include communicating the prediction(s) of the future state. For example, transaction service provider system 102 may communicate the prediction(s) to a first entity system associated with the first entity.

In some non-limiting embodiments or aspects, the time series data may include payment transaction data and the future state may include a net settlement position of the first entity, as described herein. For example, transaction service provider system 102 may communicate the at least one prediction of the net settlement position to a first entity system (e.g., issuer system 104, user device 106, merchant system 108, acquirer system 110, and/or the like) associated with the first entity (e.g., an issuer, a customer/cardholder, a merchant, an acquirer, and/or the like, respectively).

In some non-limiting embodiments or aspects, communicating the at least one prediction may include communicating (e.g., by transaction service provider system 102) the at least one prediction to the first entity system via at least one of a graphical user interface (GUI) or an application programming interface (API).

In some non-limiting embodiments or aspects, additional output data may be communicated with or in addition to the prediction(s). For example, the additional output data may include entity (e.g., FTSRE) identifier, latest date that actual settlement value is available, date(s) for the prediction(s), day identifier numbers for each of the date(s), value(s) (e.g., in currency) for each prediction, last known actual net settlement position, currency name, business identifier (e.g., BID), settlement service identifier, entity name, region, country, pilot indicator (e.g., if entity is participating in a pilot program), type of net settlement position (e.g., credit (CR) or debit (DB)), name associated with business identifier, date that the prediction(s) were generated, any combination thereof, and/or the like.

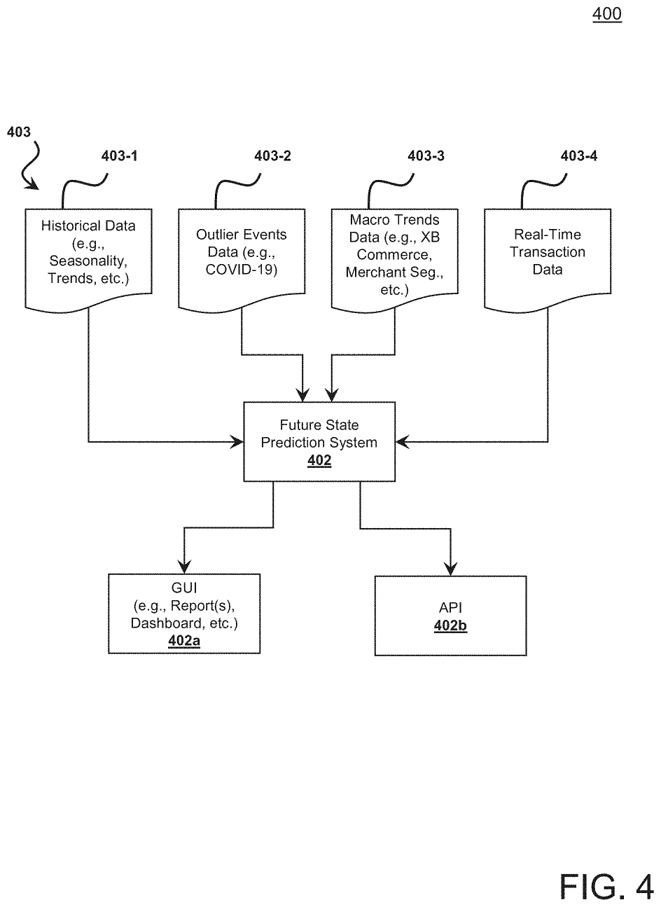

Referring now to FIG. 4, FIG. 4 is a diagram of an exemplary implementation 400 of process 300 shown in FIG. 3, according to non-limiting embodiments or aspects of the presently disclosed subject matter. As shown in FIG. 4, implementation 400 may include time series data 403 (e.g., including historical data 403-1, outlier events data 403-2, macro trends data 403-3, real-time transaction data 403-4, any combination thereof, and/or the like), future state prediction system 402, GUI 402a, and/or API 402b. In some non-limiting embodiments or aspects, at least one of (e.g., all of) future state prediction system 402, GUI 402a, and/or API 402b may be the same as, similar to, and/or part of transaction service provider system 102.

In some non-limiting embodiments or aspects, historical data 403-1 may include historical payment transaction data, historical settlement position data, daily settlement data, seasonality data, historical trends data, any combination thereof, and/or the like.

In some non-limiting embodiments or aspects, outlier events data 403-2 may include data associated with events that impact payment transactions and/or settlement positions, such as a pandemic (e.g., COVID-19), a natural disaster, a war, a conflict, any combination thereof, and/or the like.

In some non-limiting embodiments or aspects, macro trends data 403-3 may include data associated with trends that impact payment transactions and/or settlement positions (e.g., trends that impact multiple entities), such as cross border (XB) commerce, merchant segmentation, any combination thereof, and/or the like.

In some non-limiting embodiments or aspects, real-time transaction data 403-4 may include data associated with a plurality of payment transactions received in real time (or near real time, e.g., the same day as the payment transaction and/or the like), such as real-time authorization data (e.g., authorization requests and/or authorization responses), settlement data (e.g., settlement messages and/or clearing messages), any combination thereof, and/or the like.

In some non-limiting embodiments or aspects, future state prediction system 402 (e.g., a subsystem of transaction service provider system 102) may receive time series data 403 (e.g., at least one of historical data 403-1, outlier events data 403-2, macro trends data 403-3, real-time transaction data 403-4, any combination thereof, and/or the like), as described herein. Additionally or alternatively, future state prediction system 402 may determine a plurality of features based on time series data 403, as described herein. Additionally or alternatively, future state prediction system 402 may input the plurality of features into at least one machine learning model to provide at least one prediction of a net settlement position of a first entity, as described herein. Additionally or alternatively, future state prediction system 402 may communicate the prediction(s) of the net settlement position, as described herein.

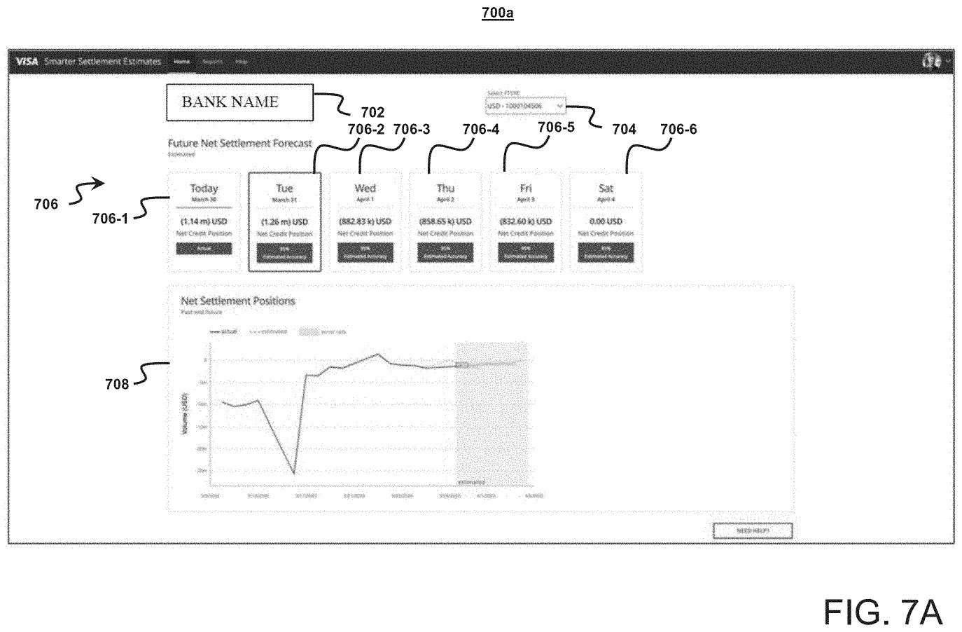

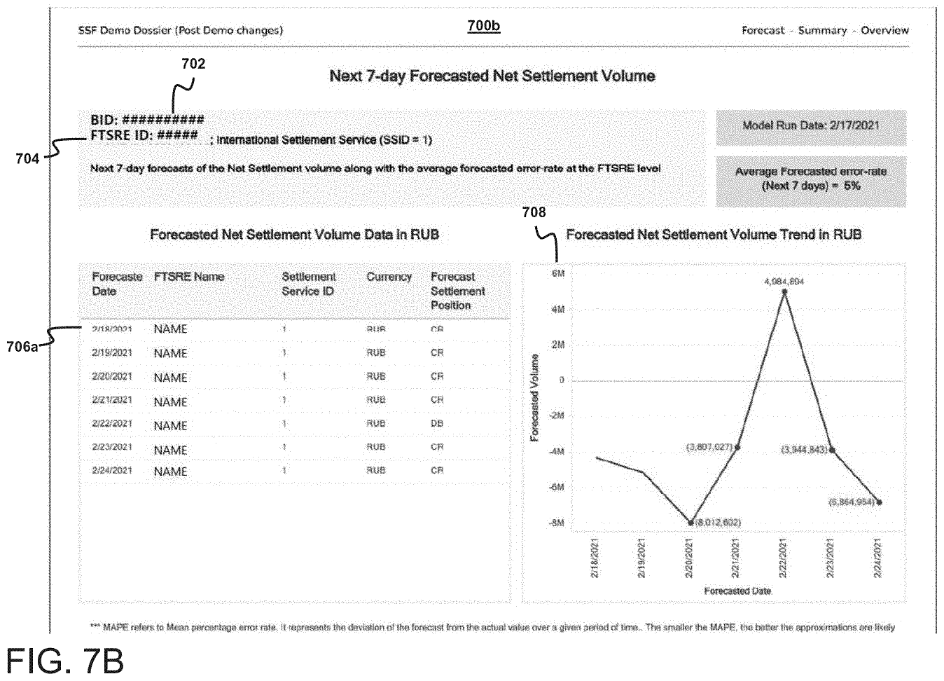

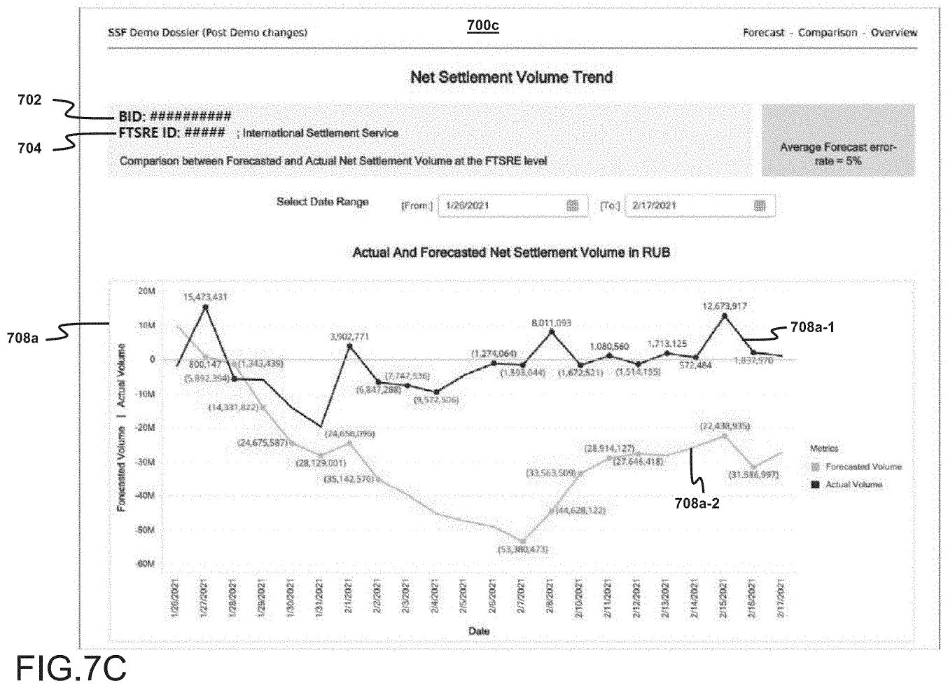

In some non-limiting embodiments or aspects, future state prediction system 402 may communicate the prediction(s) by displaying the prediction(s), at least one report based on the prediction(s), at least one dashboard based on the prediction(s), any combination thereof, and/or the like via GUI 402a. For example, FIGS. 7A-7C show exemplary GUIs 402a, according to some non-limiting embodiments or aspects. In some non-limiting embodiments or aspects, GUI 402a may be displayed on a device associated with future state prediction system 402 and/or transaction service provider system 102. Additionally or alternatively, GUI 402a may be displayed on a device separate from future state prediction system 402 and transaction service provider system 102, such as a device associated with issuer system 104, user device 106, a device associated with merchant system 108, a device associated with acquirer system 110, and/or the like.

In some non-limiting embodiments or aspects, future state prediction system 402 may communicate the prediction(s), at least one report based on the prediction(s), at least one dashboard based on the prediction(s), any combination thereof, and/or the like via API 402b. For example, future state prediction system 402 and/or transaction service provider system 102 may communicate the prediction(s), report(s), and/or dashboard(s) via API 402b to a device and/or system separate from future state prediction system 402 and transaction service provider system 102, such as issuer system 104, user device 106, merchant system 108, acquirer system 110, and/or the like.

In some non-limiting embodiments or aspects, the at least one machine learning model may include at least one of an additive regression model, a Prophet model, any combination thereof, and/or the like, as described herein. For example, the Prophet model may include an additive regression model comprising at least one of a piecewise linear or logistic growth curve trend, a yearly seasonal component modeled using Fourier series, a weekly seasonal component, a list of holidays, any combination thereof, and/or the like.

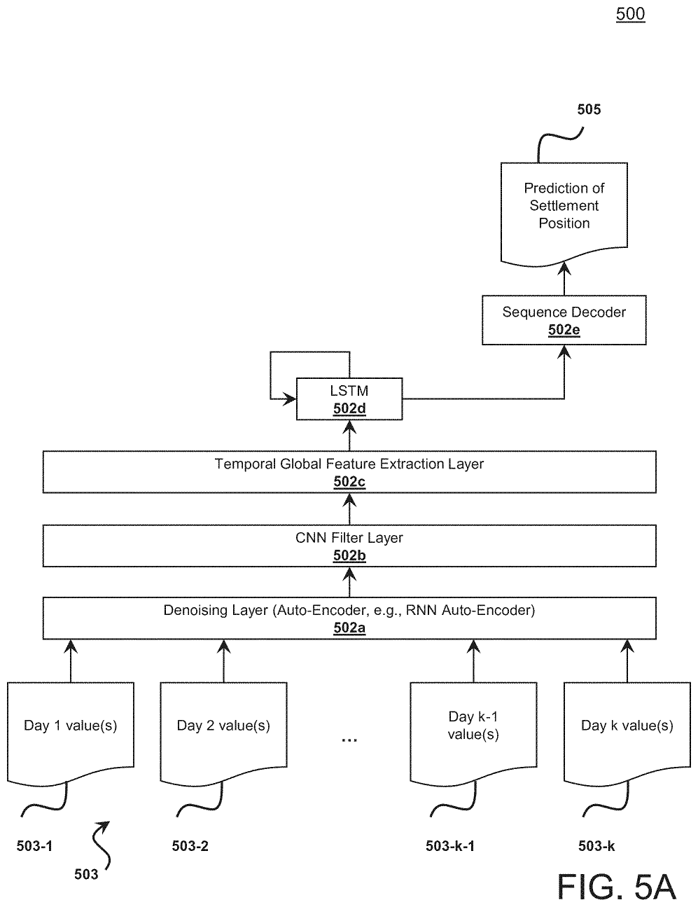

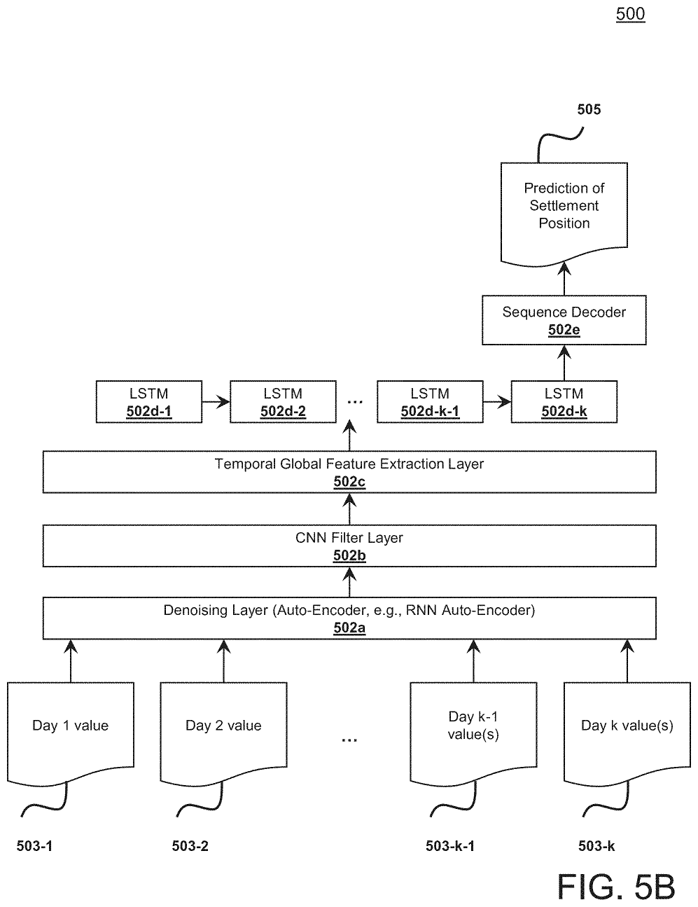

In some non-limiting embodiments or aspects, the at least one machine learning model may include a DAE, a CNN, at least one feature extraction layer, and/or an LSTM model, as described herein. For example, FIGS. 5A and 5B show exemplary machine learning models, according to some non-limiting embodiments or aspects.

Referring now to FIGS. 5A and 5B, FIGS. 5A and 5B are diagrams of an exemplary implementation 500 of process 300 shown in FIG. 3, according to non-limiting embodiments or aspects of the presently disclosed subject matter. As shown in FIGS. 5A and 5B, implementation 500 may include time series data 503 (e.g., including day one value(s) 503-1 through day k value(s) 503-k), denoising layer 502a, CNN filter layer 502b, temporal global feature extraction layer 502c, LSTM 502d, sequence decoder 502e, and prediction of settlement position 505. In some non-limiting embodiments or aspects, at least one of (e.g., all of) denoising layer 502a, CNN filter layer 502b, temporal global feature extraction layer 502c, LSTM 502d, and/or sequence decoder 502e may be the same as, similar to, and/or part of future state prediction system 402 and/or transaction service provider system 102.

In some non-limiting embodiments or aspects, day one value(s) 503-1 through day k value(s) 503-k each may include the respective value(s) of features of time series data 503 for a respective day within a period of k days, as described herein.

In some non-limiting embodiments or aspects, each respective day's value(s) of the features of time series data 503 may be inputted (e.g., by future state prediction system 402 and/or transaction service provider system 102) into the machine learning models (e.g., denoising layer 502a, CNN filter layer 502b, temporal global feature extraction layer 502c, LSTM 502d, and/or sequence decoder 502e). For example, each respective day's value(s) of the features of time series data 503 may be inputted (e.g., by future state prediction system 402 and/or transaction service provider system 102) into a denoising layer 502a, which may include a DAE, to provide denoised features. In some non-limiting embodiments or aspects, the DAE may include a recurrent neural network (RNN) autoencoder.

In some non-limiting embodiments or aspects, the denoised features may be inputted (e.g., by future state prediction system 402 and/or transaction service provider system 102) into CNN filter layer 502b, which may include at least one CNN, to provide filtered data.

In some non-limiting embodiments or aspects, the filtered data may be inputted (e.g., by future state prediction system 402 and/or transaction service provider system 102) into temporal global feature extraction layer 502c, which may include at least one feature extraction layer, to provide extracted features. In some non-limiting embodiments or aspects, the at least one feature extraction layer may include at least one fully connected neural network layer.

In some non-limiting embodiments or aspects, at least one of the plurality of features or the extracted features may be inputted (e.g., by future state prediction system 402 and/or transaction service provider system 102) into LSTM 502d to provide the at least one prediction of settlement position 505 of at least one entity (e.g., a selected entity, such as a first entity and/or the like). In some non-limiting embodiments or aspects, LSTM 502d may have a hidden state, which may be updated after each respective day's value(s) of the features of time series data 503 are inputted into the machine learning models. For example, LSTM 502d may initially have a first hidden state before day one value(s) 503-1 are inputted into the machine learning models, and LSTM 502d with this first hidden state may be referred to as LSTM 502d-1. After day one value(s) 503-1 are inputted and before day two value(s) 503-2 are inputted, LSTM 502d may initially have a second hidden state, and LSTM 502d with this second hidden state may be referred to as LSTM 502d-2, and so on. As such, after day k−1 value(s) 503-k−1 are inputted and before day k value(s) 503-k are inputted, LSTM 502d may initially have a kth hidden state, and LSTM 502d with this kth hidden state may be referred to as LSTM 502d-k.

In some non-limiting embodiments or aspects, to provide the at least one prediction of settlement position 505, an output of LSTM 502d may be inputted (e.g., by future state prediction system 402 and/or transaction service provider system 102) to sequence decoder 502e, which may provide the prediction(s) of settlement position 505.

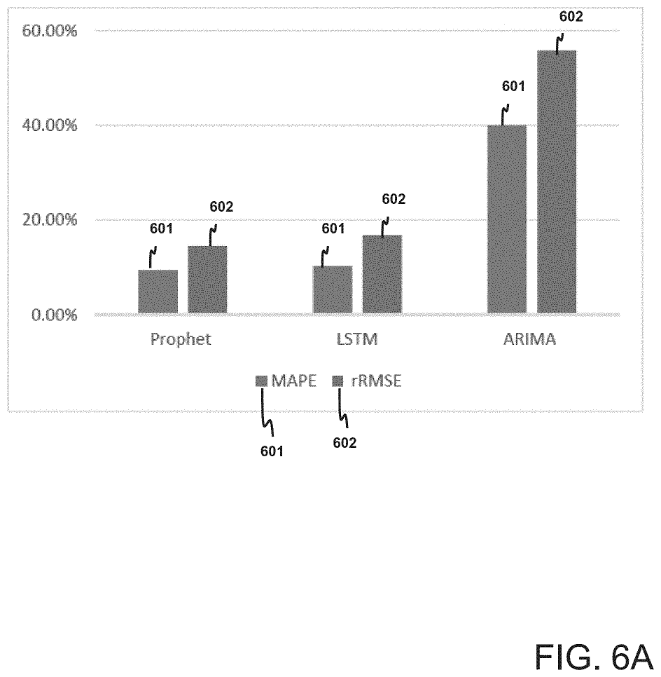

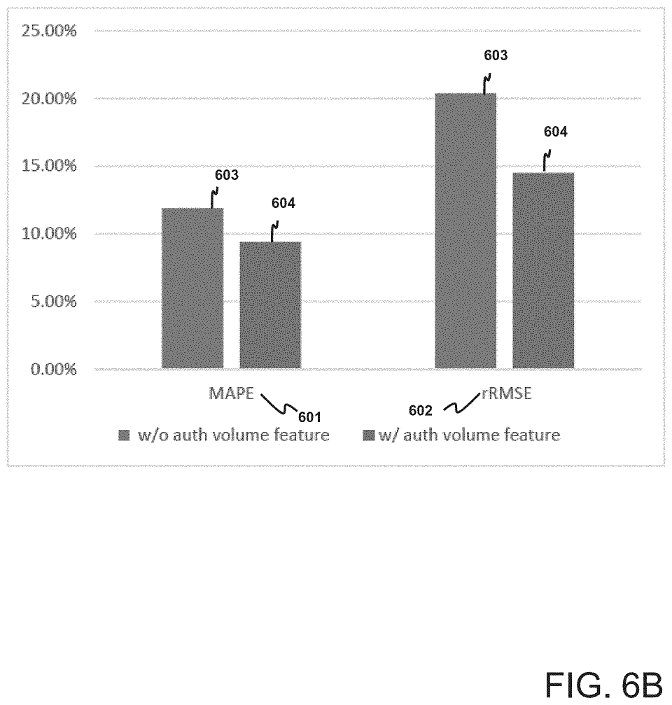

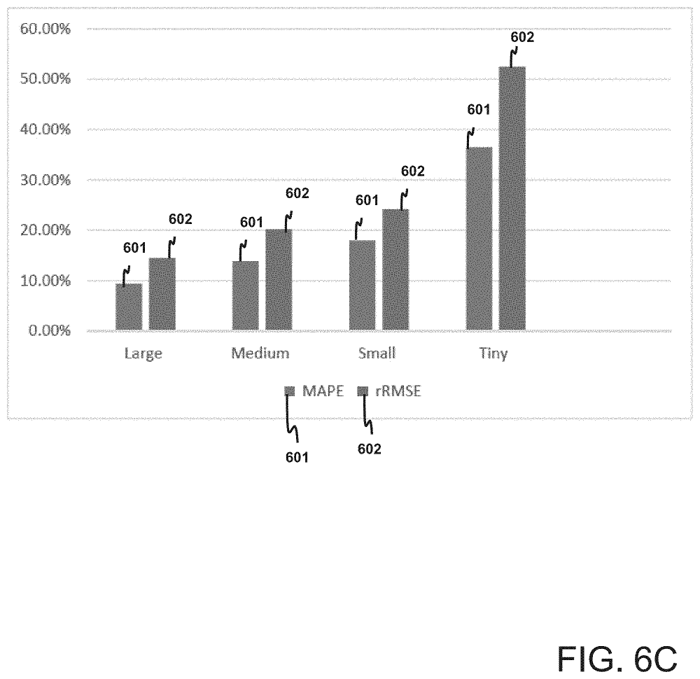

Referring now to FIGS. 6A-6C, FIGS. 6A-6C are bar graphs of exemplary performance metrics of an exemplary implementation of process 300 shown in FIG. 3, according to non-limiting embodiments or aspects of the presently disclosed subject matter. As shown in FIGS. 6A-6C, the vertical axis represents percentages and the horizontal axis represents categories.

With reference to FIG. 6A, shown are the mean absolute percentage error (MAPE) 601 and relative root mean squared error (rRMSE) 602 for predicted net settlement position using three different types of machine learning models: Prohpet, LSTM, and autoregressive integrated moving average (ARIMA). The values for the median MAPE and median rRMSE for each of these types of models are shown in Table

TABLE 1

| Model | Median MAPE | Median rRMSE |
|---|---|---|
| Prophet model | 9.4% | 14.5% |
| Preliminary RNN (e.g., | 10.3% | 16.8% |
| DAE) with LSTM | | |
| ARIMA | 40.0% | 55.8% |

As demonstrated by FIG. 6A and Table 1, the Prophet model and the LSTM (with preliminary RNN/DAE, as described herein) have similar performance (e.g., similar error by both metrics), and both of the aforementioned models outperform ARIMA (e.g., ARIMA has higher error by both metrics). As such, performance is improved when the machine learning models described herein are utilized, rather than other types and arrangements of machine learning models.

With reference to FIG. 6B, shown are the MAPE 601 and rRMSE 602 for predicted net settlement position without authorization volume as a feature (603) and with authorization volume as a feature (604). As demonstrated by FIG. 6B, performance is better (e.g., lower error by both metrics) when authorization volume is included as a feature. As such, performance is improved when the feature determination/selection described herein is utilized, rather than choosing features without such feature engineering.

With reference to FIG. 6C, shown are the mean absolute percentage error (MAPE) 601 and relative root mean squared error (rRMSE) 602 for predicted net settlement position for the following sizes of entities (e.g., FTSREs): large (e.g., AADV greater than 10 million), medium (AADV between 100 thousand and 10 million), small (AADV between 10 thousand and 100 thousand), and tiny (AADV less than 10 thousand). As demonstrated by FIG. 6C, performance is better (e.g., lower error by both metrics) when for entities with larger authorization volume (e.g., AADV).

Referring now to FIGS. 7A-7C, FIGS. FIGS. 7A-7C are screenshots of exemplary graphical user interfaces of exemplary implementations of the process shown in FIG. 3, according to non-limiting embodiments or aspects of the presently disclosed subject matter.

With reference to FIG. 7A, GUI 700a may include the entity name 702, account identifier 704, predictions 706, and graph 708. In some non-limiting embodiments or aspects, a user may select account identifier 704 (e.g., from among a plurality of account identifiers associated with and/or accessible by the user) in a dropdown menu. For example, in response to selection of account identifier 704, entity name 702 associated with account identifier 704 may be displayed, predictions 706 associated with account identifier 704 may be displayed, and/or graph 708 (e.g., based on predictions 706) may be displayed.

In some non-limiting embodiments or aspects, predictions 706 may include a first box 706-1 associated with a first subperiod (e.g., day), a second box 706-2 associated with a second subperiod, a third box 706-3 associated with a third subperiod, a fourth box 706-4 associated with a fourth subperiod, a fifth box 706-5 associated with a fifth subperiod, a sixth box 706-6 associated with a sixth subperiod, and so on for every subperiod in a time period. In some non-limiting embodiments or aspects, each respective box may include a respective value of the predicted state for that subperiod (e.g., a respective value of predicted net settlement position for the respective day). Additionally or alternatively, each respective box may include a respective confidence value (e.g., estimated accuracy) for the respective predicted state (e.g., predicted net settlement position) of the respective subperiod.

In some non-limiting embodiments or aspects, graph 708 may include any suitable graph (e.g., line graph, bar graph, any combination thereof, and/or the like) of the respective value of the predicted state (e.g., a respective value of predicted net settlement position) for each respective subperiod (e.g., each respective day). For example, as shown in FIG. 7A, graph 708 includes a line graph, with a vertical axis representing the value of predicted net settlement position (e.g., in units of currency, such as US dollars (USD)) and a horizontal axis representing each subperiod (e.g., day) in the period.

With reference to FIG. 7B, GUI 700b may include the entity name 702, account identifier 704, predictions table 706a, and graph 708. In some non-limiting embodiments or aspects, predictions table 706a may include a row for each subperiod (e.g., day) in a period and respective columns for the predicted/forecasted date, the report creation date, day identifier number for each of the predicted/forecasted dates, entity name, entity identifier, business identifier, name associated with business identifier, settlement service identifier, currency (e.g., US dollars (USD), rubles (RUB), and/or the like), predicted/forecasted settlement position (e.g., credit (CR) or debit (DB)), value of predicted net settlement position, any combination thereof, and/or the like.

With reference to FIG. 7B, GUI 700b may include the entity name 702, account identifier 704, and comparison graph 708a. In some non-limiting embodiments or aspects, comparison graph 708a may include any suitable graph (e.g., line graph, bar graph, any combination thereof, and/or the like) of the respective value of the predicted state (e.g., a respective value of predicted net settlement position) and the respective value of the actual state (e.g., a respective value of actual net settlement position) for each respective subperiod (e.g., each respective day). For example, as shown in FIG. 7C, comparison graph 708a includes a line graph, with a vertical axis representing the value of net settlement position (e.g., in units of currency, such as rubles (RUB)), a horizontal axis representing each subperiod (e.g., day) in the period, a first curve 708a-1 representing the actual value of the net settlement position, and a second curve 708a-2 representing the predicted/forecasted value of the net settlement position.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

What is claimed is:

1. A computer-implemented method, comprising:
receiving, with at least one processor, payment transaction data associated with a plurality of payment transactions, the plurality of payment transactions including a first subset of payment transactions associated with a first entity;
determining, with the at least one processor, a plurality of features based on the payment transaction data associated with the plurality of payment transactions;
inputting, with the at least one processor, the plurality of features into at least one machine learning model to provide at least one prediction of a net settlement position of the first entity; and
communicating, with the at least one processor, the at least one prediction of the net settlement position to a first entity system associated with the first entity.

2. The computer-implemented method of claim 1, wherein the payment transaction data associated with each transaction of the first subset of payment transactions comprises an account identifier associated with the first entity.

3. The computer-implemented method of claim 2, wherein the account identifier comprises at least one of a settlement reporting entity (SRE) number, a funds transfer SRE (FTSRE) number, a business identification (BID) number, or any combination thereof.

4. The computer-implemented method of claim 1, wherein the payment transaction data comprises at least one of historical transaction data, historical settlement position data, daily settlement data, real-time authorization data, or any combination thereof.

5. The computer-implemented method of claim 1, wherein determining the plurality of features comprises determining the plurality of features based on a random forest model.

6. The computer-implemented method of claim 5, wherein determining the plurality of features based on the random forest model comprises:
receiving a first plurality of features;
evaluating the first plurality of features with the random forest model to rank the first plurality of features based on a respective level of impact of each respective features of the first plurality of features on an output of the at least one machine learning model; and
selecting a second plurality of features based on ranking of the first plurality of features, wherein the second plurality of features comprises the plurality of features.

7. The computer-implemented method of claim 1, wherein the at least one machine learning model comprises at least one of an additive regression model, a Prophet model, or any combination thereof.

8. The computer-implemented method of claim 7, wherein the Prophet model comprises the additive regression model comprising at least one of:
a piecewise linear or logistic growth curve trend;
a yearly seasonal component modeled using Fourier series;
a weekly seasonal component;
a list of holidays; or
any combination thereof.

9. The computer-implemented method of claim 1, wherein inputting the plurality of features into the at least one machine learning model comprises:
inputting the plurality of features into a denoising autoencoder (DAE) to provide denoised features;
inputting the denoised features into a convolutional neural network (CNN) to provide filtered data;
inputting the filtered data into at least one feature extraction layer to provide extracted features; and
inputting at least one of the plurality of features or the extracted features into a long short-term memory (LSTM) model to provide the at least one prediction of the net settlement position of the first entity.

10. The computer-implemented method of claim 9, wherein the DAE comprises a recurrent neural network (RNN) autoencoder.

11. The computer-implemented method of claim 9, wherein the at least one feature extraction layer comprises at least one fully connected neural network layer.

12. The computer-implemented method of claim 9, wherein inputting the at least one of the plurality of features or the extracted features into the LSTM model to provide the at least one prediction comprises inputting an output of the LSTM model to a sequence decoder to provide the at least one prediction.

13. The computer-implemented method of claim 1, wherein the at least one prediction comprises a plurality of predictions comprising a respective prediction of the net settlement position of the first entity for each subperiod of a time period.

14. The computer-implemented method of claim 13, wherein the time period comprises seven days, each subperiod comprises one day of the seven days, and the plurality of predictions comprises a first prediction for a first day of the seven days, a second prediction for a second day of the seven days, a third prediction for a third day of the seven days, a fourth prediction for a fourth day of the seven days, a fifth prediction for a fifth day of the seven days, a sixth prediction for a sixth day of the seven days, and a seventh prediction for a seventh day of the seven days.

15. The computer-implemented method of claim 1, wherein communicating the at least one prediction comprises communicating the at least one prediction to the first entity system via at least one of a graphical user interface (GUI) or an application programming interface (API).

16. A system, comprising:
at least one processor; and
at least one non-transitory computer-readable medium including one or more instructions that, when executed by the at least one processor, direct the at least one processor to:
receive payment transaction data associated with a plurality of payment transactions, the plurality of payment transactions including a first subset of payment transactions associated with a first entity;
determine a plurality of features based on the payment transaction data associated with the plurality of payment transactions;
input the plurality of features into at least one machine learning model to provide at least one prediction of a net settlement position of the first entity; and
communicate the at least one prediction of the net settlement position to a first entity system associated with the first entity.

17. The system of claim 16, wherein determining the plurality of features comprises determining the plurality of features based on a random forest model, and wherein determining the plurality of features based on the random forest model comprises:
receiving a first plurality of features;
evaluating the first plurality of features with the random forest model to rank the first plurality of features based on a respective level of impact of each respective features of the first plurality of features on an output of the at least one machine learning model; and
selecting a second plurality of features based on ranking of the first plurality of features, wherein the second plurality of features comprises the plurality of features.

18. The system of claim 16, wherein the at least one machine learning model comprises at least one of an additive regression model, a Prophet model, or any combination thereof, and wherein the Prophet model comprises the additive regression model comprising at least one of:
a piecewise linear or logistic growth curve trend;
a yearly seasonal component modeled using Fourier series;
a weekly seasonal component;
a list of holidays; or
any combination thereof.

19. The system of claim 16, wherein inputting the plurality of features into the at least one machine learning model comprises:
inputting the plurality of features into a denoising autoencoder (DAE) to provide denoised features;
inputting the denoised features into a convolutional neural network (CNN) to provide filtered data;
inputting the filtered data into at least one feature extraction layer to provide extracted features; and
inputting at least one of the plurality of features or the extracted features into a long short-term memory (LSTM) model to provide the at least one prediction of the net settlement position of the first entity.

20. A computer program product comprising at least one non-transitory computer-readable medium including one or more instructions that, when executed by at least one processor, cause the at least one processor to:
receive payment transaction data associated with a plurality of payment transactions, the plurality of payment transactions including a first subset of payment transactions associated with a first entity;
determine a plurality of features based on the payment transaction data associated with the plurality of payment transactions;
input the plurality of features into at least one machine learning model to provide at least one prediction of a net settlement position of the first entity; and
communicate the at least one prediction of the net settlement position to a first entity system associated with the first entity.
